(19) United States
(12) Patent Application Publication
(10) Pub. No.: US 2025/0249772 A1
(43) Pub. Date: Aug. 7, 2025

(54) INDUCTION CHARGING APPARATUS, VEHICLE INDUCTION CHARGING APPARATUS, ENERGY TRANSFER APPARATUS, COMBINATION OF AN ENERGY TRANSFER APPARATUS AND A BATTERY-ELECTRIC VEHICLE, AND METHOD FOR BRINGING A BATTERY-ELECTRIC VEHICLE EQUIPPED WITH A VEHICLE INDUCTION CHARGING APPARATUS TO AN INDUCTION CHARGING APPARATUS

(71) Applicant: MAHLE International GmbH, Stuttgart (DE)

(72) Inventor: Mike Boettigheimer, Kornwestheim (DE)

(21) Appl. No.: 18/854,513

(22) PCT Filed: Mar. 28, 2023
(86) PCT No.: PCT/EP2023/057940

§ 371 Date: Oct. 4, 2024

(30) Foreign Application Priority Data
Apr. 7, 2022 (DE) 10 2022 203 492.9

(51) Int. Cl. B60L 53/36; B60L 53/126; B60L 53/38

(52) U.S. Cl. CPC B60L 53/36; B60L 53/126; B60L 53/38

(57) ABSTRACT

An induction charging apparatus for a charging station configured for charging a battery-electric vehicle with electrical energy is disclosed. The induction charging apparatus includes a support structure and an electrical energy coil configured for inductive interaction with an electrical vehicle energy coil of a vehicle induction charging apparatus of the vehicle. A transmitting device is provided that includes at least one electrical transmission coil separate with respect to the energy coil, the at least one transmission coil provides an electromagnetic field or a magnetic field. A guide is provided using at least one FP marking field for the vehicle induction charging apparatus of the vehicle, via which the vehicle induction charging apparatus of the vehicle can be guided to the electrical energy coil.

### CROSS-REFERENCE TO RELATED APPLICATIONS

This application claims priority to International Patent Application No. PCT/EP2023/057940 filed on Mar. 28, 2023, which also claims priority to German Patent Application DE 10 2022 203 492.9 filed on Apr. 7, 2022, the contents of each of which is hereby incorporated by reference in its entirety.

### TECHNICAL FIELD

The invention relates to an induction charging apparatus. The invention also relates in particular to a vehicle induction charging apparatus, further in particular to an energy transfer apparatus, further in particular to a combination of an energy transfer apparatus and a battery-electric vehicle and further in particular to a method for bringing a battery-electric vehicle equipped with a vehicle induction charging apparatus to an induction charging apparatus.

### BACKGROUND

Inductive, contactless energy transfer can be used to charge a battery-powered vehicle, in particular an electric vehicle. An energy coil of an induction charging apparatus, also referred to as a primary coil, is located on the ground of a parking space. The vehicle-side, mobile energy coil of a vehicle induction charging apparatus, also known as the secondary coil, is arranged on the vehicle. The advantage here is that no charging cables need to be plugged in manually when the vehicle is to be supplied with energy. In charging mode, it is necessary for the two inductively interacting, energy-transferring energy coils to be as precisely opposite one another as possible and for a transverse offset to lie within a tolerance band specified in the SAE J2954 or IEC 61980 standard, for example. The basic principle here is that the more accurate the positioning, the better the coupling between the energy coils and the greater the overall efficiency of the non-contact energy transfer. For this reason, there is a fundamental need to position the mobile energy coil on the vehicle side as precisely as possible on the energy coil on the ground side. Known solutions require sensors to be installed in the vehicle, such that additional installation space must be provided there, which as regards vehicle development is undesirable. Furthermore, known solutions are relatively susceptible to various weather conditions and/or environmental influences such as dirt.

The object the invention is thus to provide an improved or at least a different embodiment of an induction charging apparatus. In particular, a vehicle induction charging apparatus, further in particular an energy transfer apparatus, further in particular a combination of an energy transfer apparatus and a battery-electric vehicle, and further in particular a method for bringing a battery-electric vehicle equipped with a vehicle induction charging apparatus to an induction charging apparatus are to be disclosed.

In the present invention, this object is achieved in particular by the subject-matters of the independent claim(s). Advantageous embodiments are the subject-matter of the dependent claims and of the description.

### SUMMARY

The basic idea of the invention is to equip an induction charging apparatus with a transmitting device comprising at least one electrical transmission coil that is separate with respect to the energy coil of the induction charging apparatus and that provides an electromagnetic or magnetic field that can be detected and evaluated with the aid of a vehicle induction charging apparatus of a vehicle, in particular an electric vehicle.

For this purpose, an induction charging apparatus is proposed for a mobile or stationary charging station configured for charging a battery-electric vehicle, in particular an electric vehicle, with electrical energy, which is equipped with a support structure on, in or next to which an electrical energy coil is arranged, which is configured for inductive interaction with an electrical vehicle energy coil of a vehicle induction charging apparatus of the battery-electric vehicle, such that electrical energy can be transferred inductively from the induction charging apparatus to the battery-electric vehicle, or vice versa. The induction charging apparatus also comprises a transmitting device that comprises at least one transmission coil that is separate with respect to the electrical energy coil, hereinafter referred to as the guide-path-marking transmission coil or FPM transmission coil, which transmission coil provides an electromagnetic or magnetic field, hereinafter referred to as the guide-path-marking field or FP marking field, or is configured to provide such a field. With the aid of the at least one FP marking field for the vehicle induction charging apparatus of the vehicle, a guide, in particular a guide path, is provided, using which it is possible to supply the vehicle induction charging apparatus of the battery-electric vehicle or the battery-electric vehicle to the electrical energy coil. In principle, it is also conceivable that the induction charging apparatus is arranged in a vehicle, such that the vehicle provides the guide path.

With the aid of the proposed induction charging apparatus, a vehicle induction charging apparatus of a battery-electric vehicle or the battery-electric vehicle, in particular an electric vehicle, which is brought from a distance into a close range of the induction charging apparatus, for example within the framework of a remote positioning method, can be brought directly to the electrical energy coil of the induction charging apparatus. This allows an effective charging operation with a comparatively high overall efficiency to be carried out or established, since a vehicle induction charging apparatus optimally positioned on the electrical energy coil makes possible a comparatively loss-free energy transfer between the vehicle induction charging apparatus and the induction charging apparatus. In particular, with the aid of the guide or the guide path, a user of the vehicle or a control device of the same may be given the opportunity to prepare for a stop signal issued upon reaching the electric energy coil and/or for a stop of the vehicle. As a result, a convenient, safe and simple approach of the vehicle induction charging apparatus of the battery-electric vehicle or the battery-electric vehicle to the induction charging apparatus is possible.

Said induction charging apparatus can expediently be used in a charging station that is configured for charging any battery-electric apparatuses with electrical energy, wherein battery-electric apparatuses are only optionally battery-electric vehicles. Here, the electrical energy coil of the induction charging apparatus can be configured for inductive interaction with an electrical counter-energy coil of any battery-electric apparatus, such that electrical energy can be transferred inductively from the induction charging apparatus to any battery-electric apparatus, or vice versa.

Expediently, the induction charging apparatus can realize a mobile induction charging apparatus that is installed in a vehicle, for example, and expediently realizes a vehicle induction charging apparatus there.

Furthermore, the induction charging apparatus can expediently realize a stationary induction charging apparatus, which is arranged, for example, completely or at least in sections within a surface.

In particular, the support structure can form a support structure arranged on or in a surface on which the vehicle is parked. As a result, the support structure can be advantageously realized as an above-ground or a below-ground solution. Expediently, the support structure can be placed in a concrete segment or asphalted into an asphalt layer and/or not fitted with a plastic cover. Furthermore, the support structure can define a vertical direction and/or form a flat housing whose extent transverse to the vertical direction is greater than in the vertical direction. The guide or the guide path can be oriented transversely to the vertical direction and, in particular, parallel to a surface on which the vehicle is parked.

It is expedient if the at least one FPM transmission coil is arranged away from the electrical energy coil and/or at a distance from the electrical energy coil on the support structure. In particular, the at least one FPM transmission coil can be arranged on the support structure between the electrical energy coil and the battery-electric vehicle in a direction of travel defined by the battery-electric vehicle. As a result, a favorable guidance of the battery-electric vehicle to the electric energy coil can be realized.

Due to the use of electromagnetic or magnetic fields for positioning, the proposed transmitting device of the induction charging apparatus is in particular insensitive to weather conditions and/or environmental influences such as dirt, etc.

Expediently, the vertical direction is perpendicular to a housing wall of the support structure that faces away from the surface on which said vehicle is parked. The housing wall expediently has or forms a flat outer large surface, which in particular is opposed to an inner surface of the housing wall facing an inner space of the support structure, wherein the vertical direction is perpendicular to the outer large surface.

Expediently, the electrical energy coil spans a coil plane, wherein the support structure defines a vertical direction that is aligned orthogonally with respect to the coil plane.

The electrical energy coil is expediently arranged within the support structure and further expediently parallel to an upper side of the support structure and further expediently extends in the direction of a longitudinal direction perpendicular to the vertical direction and in the direction of a transverse direction that is perpendicular to the vertical direction and perpendicular to the longitudinal direction. The vehicle energy coil, in a charging operation or to establish such an operation, can be arranged at least in sections or completely within a target region of the induction charging apparatus defined using the electrical energy coil. The target region can expediently be realized by a target volume, which is expediently arranged above the support structure in the vertical direction and is further expediently defined by a height extending in the vertical direction, by a width extending in a longitudinal direction perpendicular to the vertical direction and by a depth extending in a transverse direction perpendicular to the vertical direction and perpendicular to the longitudinal direction.

It can be expediently provided that the at least one FPM transmission coil is arranged spaced apart from the electrical energy coil on the support structure in a longitudinal direction perpendicular to the vertical direction. It can also be provided that the at least one FPM transmission coil is positioned in an inner space delimited or formed by the support structure and/or is arranged on an inner surface of a housing wall of the support structure that is oriented towards the inner space. Said housing wall of the support structure can in particular also face away from a surface on or in which the induction charging apparatus is arranged and/or be realized as a design hood that is recognizable to a user from the outside. As a result, a preferred arrangement of the FPM transmission coil on the support structure is specified, as a result of which for example, a favorable guide or guide path can be realized.

Expediently, it can be further provided that the at least one FPM transmission coil is a flat coil. Furthermore, the at least one FPM transmission coil can be designed to be smaller than the electrical energy coil, in particular with regard to its coil surface. Furthermore, the at least one FPM transmission coil can have a circular outer contour and as a result form a circular FPM transmission coil. Furthermore, the at least one FPM transmission coil can comprise a rectangular outer contour and form a rectangular coil. It is also expedient if the at least one FPM transmission coil is or forms a long coil that extends in a main coil direction, wherein the extent of the long coil is expediently greater in the main coil direction than in a transverse coil direction perpendicular to the main coil direction. Furthermore, the main coil direction can be aligned perpendicularly with respect to a vertical direction of the support structure. Alternatively, the main coil direction can be perpendicular with respect to a longitudinal direction perpendicular to a vertical direction of the support structure. As a result, preferred coil geometries for the at least one FPM transmission coil are specified.

It can further be expediently provided that the FP marking field provided or to be provided by the at least one FPM transmission coil is a long magnetic field that extends in a main field direction, in particular an oval or cigar-shaped long field when viewed in the vertical direction. Furthermore, the extent of the long field can be greater in the main field direction than in a transverse field direction perpendicular to the main field direction. Furthermore, the main field direction can be perpendicular with respect to the vertical direction or the main field direction can be perpendicular with respect to a longitudinal direction perpendicular to the vertical direction. As a result, a preferred shape for at least one FP marking field is specified. Expediently, the at least one SP marking field can also be realized by a magnetic long field that extends in a main field direction, wherein the extent of the long field of the at least one SP marking field is expediently greater in the main field direction than in a transverse field direction perpendicular to the main field direction.

It can be expediently provided that the FP marking field provided or to be provided by the at least one FPM transmission coil has a marking intensity maximum. Here, the marking intensity maximum can form at least one global maximum, wherein the marking intensity maximum is expediently spaced apart from the energy coil with respect to the vertical direction. Theoretically, due to a double hump, two identical global maxima can also exist. On the basis of the marking intensity maximum of the at least one FPM transmission coil, a favorable guide path can already be ascertained. However, if more than one FPM transmission coil or more than one FP marking field is present, it is expedient that a ratio of the marking intensity maxima of the FP marking fields or their amplitudes is formed and on this basis a guide path is ascertained.

It can be further expediently provided that the guide, in particular the guide path, is aligned with the electrical energy coil and/or leads to the same. Expediently, the guide or the guide path runs through the FP marking field provided or providable by the at least one FPM transmission coil and/or by its marking intensity maximum. As a result, it is relatively easy to ascertain and provide a guide path.

It can be expediently provided that two, four, six or more FPM transmission coils are arranged on the support structure spaced apart from the energy coil in a longitudinal direction perpendicular to the vertical direction. The two, four, six or more FPM transmission coils can in each case be positioned in an inner space delimited or formed by the support structure and/or arranged on an inner surface of a housing wall of the support structure that is oriented towards the inner space. Said housing wall of the support structure can in particular also face away from a surface on or in which the induction charging apparatus is arranged and/or be realized as a design hood that is recognizable to a user from the outside. As a result, a preferred arrangement of the FPM transmission coils on the support structure is specified, as a result of which a favorable guide path can be realized, for example.

It can further be expediently provided that said FPM transmission coils are arranged one behind the other on a longitudinal straight line or a longitudinal curve aligned parallel with respect to the longitudinal direction, or that said FPM transmission coils are arranged one behind the other on a transverse straight line aligned parallel with respect to a transverse direction perpendicular to the vertical direction and the longitudinal direction. Furthermore, it can be provided that adjacent FPM transmission coils are spaced apart relative to one another or relative to one another in the longitudinal direction or relative to one another in the transverse direction. As a result, advantageous arrangement configurations for the FPM transmission coils are specified.

It can be expediently provided that the FP marking fields provided by FPM transmission coils can be differentiated from one another. Expediently, the differentiation can be realized using different transmission frequencies. Advantageously, the transmission coils are operated at frequencies between 5 kHz and 150 kHz. Preferably, the transmission coils are operated at frequencies between 110 kHz and 148.5 kHz, particularly preferably between 120 kHz and 145 kHz. The frequencies associated with the transmission coils are preferably spaced as closely as possible relative to one another, so that the total frequency spectrum required is narrow. The frequencies are, for example, 5 kHz or 1 kHz or 100 Hz or 1 or a few Hertz apart. Differentiation is also possible by means of duty cycles. Using said coding of the at least one FP marking field, it can advantageously be differentiated from one or more other FP marking fields, for example.

Furthermore, it can be provided that the electrical transmission coil designed as an FPM transmission coil is assigned to a ferrite element of the electrical energy coil arranged on the electrical energy coil. The ferrite element interacts with the FPM marking field of the FPM transmission coil, for example a bundling is achieved. As a result, the FPM transmission coil, which in this case is expediently arranged directly on or above the electrical energy coil, can use the ferrite element of the electrical energy coil, so to speak, as a result of which this FPM transmission coil does not have to be equipped with a separate ferrite element. Furthermore, an electrical transmission coil designed as an FPM transmission coil can be equipped with its own ferrite element. The ferrite element of the FPM transmission coil interacts with the FPM marking field of the FPM transmission coil, for example a bundling is achieved. As a result, the FPM transmission coil, which in this case is expediently placed in front of the electrical energy coil, i.e. spaced apart from it, is equipped with a ferrite element.

It is also expedient if the electrical transmission coil designed as an FPM transmission coil comprises a magnetic flux guide unit with magnetic flux guide elements, in particular ferrite plates, for guiding magnetic or electromagnetic fields, in particular the generated FP marking fields.

Expediently, the induction charging apparatus is equipped with an optional means, in particular a control unit or a computer unit, which recognizes or is configured to recognize, or performs such a recognition, on the basis of at least one received FP marking field, which in this case is detected by the vehicle induction charging apparatus or the battery-electric vehicle equipped with it, in particular an electric vehicle, and is wirelessly transferred to the induction charging apparatus, that the vehicle induction charging apparatus or the vehicle is approaching the induction charging apparatus.

According to a further basic idea, a vehicle induction charging apparatus for a battery-electric vehicle, in particular an electric vehicle, can expediently be provided, with an electric vehicle energy coil arranged in a vehicle base housing, which is configured for inductive interaction with an electric energy coil of an induction charging apparatus for a stationary charging station configured for charging battery-electric vehicles, in particular electric vehicles, with electric energy, in order to transfer electric energy inductively from the induction charging apparatus to the vehicle, or vice versa. The vehicle induction charging apparatus also comprises a receiving device arranged in the vehicle base housing, comprising at least one electrical receiver coil that receives or is configured to receive at least one magnetic field, referred to as a magnetic guide-path-marking field or FP marking field, from an electrical transmission coil, referred to as a guide-path-marking transmission coil or FPM transmission coil, of a transmitting device of the induction charging apparatus. The vehicle induction charging apparatus is optionally equipped with a means, in particular a control device or a computer unit, which, using at least one received FP marking field, recognizes or is configured to recognize, or performs such a recognition that the vehicle induction charging apparatus and/or the vehicle is approaching the induction charging apparatus. As a result, a preferred vehicle induction charging apparatus for a vehicle is specified, which can expediently interact with an induction charging apparatus as described above in the manner described.

According to a further basic idea, an energy transfer apparatus for a battery-electric vehicle, in particular an electric vehicle, can be expediently provided, with an induction charging apparatus configured for a stationary application according to the preceding description and a vehicle induction charging apparatus configured for a mobile application according to the preceding paragraph, wherein the induction charging apparatus and/or the vehicle induction charging apparatus expediently comprises a means, in particular a control device or a computer unit, which, using at least one received FP marking field, recognizes or is configured to recognize, or performs such a recognition, that the vehicle induction charging apparatus and/or the vehicle is approaching the induction charging apparatus. As a result, a preferred combination of an induction charging apparatus according to the above description and a vehicle induction charging apparatus according to the above description is specified, which can be marketed, for example, as an intermediate product.

According to a further basic idea, a combination of an energy transfer apparatus according to the preceding description and a battery-electric vehicle, in particular an electric vehicle, can expediently be provided, wherein the stationary induction charging apparatus is fastened by its support structure on the ground side to, or at least in sections recessed in, a surface on which the vehicle is parked, wherein the mobile vehicle induction charging apparatus is fastened by its vehicle base housing to a vehicle structure, in particular an underbody, of the vehicle. As a result, an advantageous combination of an energy transfer apparatus and a vehicle is specified, wherein the induction charging apparatus and the vehicle induction charging apparatus are expediently fastened. This has the particular advantage that the components of the induction charging apparatus are at least partially recessed into the ground/surface, as a result of which they do not require any space above ground and are also not at risk of vandalism. Expediently, the stationary induction charging apparatus could also be placed on the ground/surface.

According to a further basic idea, a method for bringing a vehicle induction charging apparatus according to the preceding description or a battery-electric vehicle equipped with such a vehicle induction charging apparatus, in particular an electric vehicle, to an induction charging apparatus can be expediently provided, within the framework of which method an FP marking field of at least one FPM transmission coil of the transmitting device of the induction charging apparatus is received by means of at least one electrical receiver coil of the receiving device of the vehicle induction charging apparatus, wherein a means installed in the induction charging apparatus and/or the vehicle inductive charging apparatus, in particular a control unit or a computing unit, recognizes or ascertains using at least one received FP marking field that the vehicle inductive charging apparatus and/or the vehicle is approaching the inductive charging apparatus. As a result, an advantageous method by means of which a vehicle induction charging apparatus or the vehicle equipped with the same can be brought to the induction charging apparatus at least from a close range of the induction charging apparatus is specified.

In summary, the following remains to be stated: The present invention preferably relates to an induction charging apparatus for a charging station configured for charging a battery-electric vehicle with electrical energy, with a support structure defining a vertical direction, with a transmitting device comprising electrical transmission coils separate with respect to an energy coil of the induction charging apparatus, wherein at least one first electrical transmission coil provides a magnetic field referred to as a target position marking field or SP marking field, wherein, using the at least one SP marking field for a vehicle induction charging apparatus of the vehicle, a preferred target-position target region is marked or can be marked, wherein at least one second electric transmission coil provides a magnetic field hereinafter referred to as a guide-path-marking field or FP marking field, wherein, using the at least one FP marking field for the vehicle induction charging apparatus, a guide path leading to the target-position target region is marked or provided, using which guide path the vehicle induction charging apparatus and/or the vehicle can be guided to the at least one SP marking field marking or delimiting the target-position target region. The invention relates in particular to a vehicle induction charging apparatus, further in particular to an energy transfer apparatus, further in particular to a combination of an energy transfer apparatus and a battery-electric vehicle and further in particular to a method for bringing a battery-electric vehicle equipped with a vehicle induction charging apparatus to an induction charging apparatus.

Further important features and advantages of the invention are apparent from the subclaims, from the drawings and from the associated description of the figures with reference to the drawings.

It is understood that the features mentioned above and those to be explained below can be used not only in the combination specified in each case, but also in other combinations or on their own, without departing from the scope of the present invention.

Preferred embodiments of the invention are illustrated in the drawings and are explained in more detail in the following description, wherein identical reference signs refer to identical or similar or functionally identical components.

### BRIEF DESCRIPTION OF THE DRAWINGS

The following are shown, in each case in a highly simplified and schematic manner

FIGS. 1 to 6 in each case, a plan view of an induction charging apparatus according to a preferred embodiment,

FIG. 7 the induction charging apparatus from FIG. 6 in a side view,

FIG. 8 in a plan view, an induction charging apparatus according to a preferred further embodiment and finally

FIG. 9 the induction charging apparatus from FIG. 8 in a side view,

FIG. 10 a further plan view of an induction charging apparatus according to a preferred embodiment.

### DETAILED DESCRIPTION

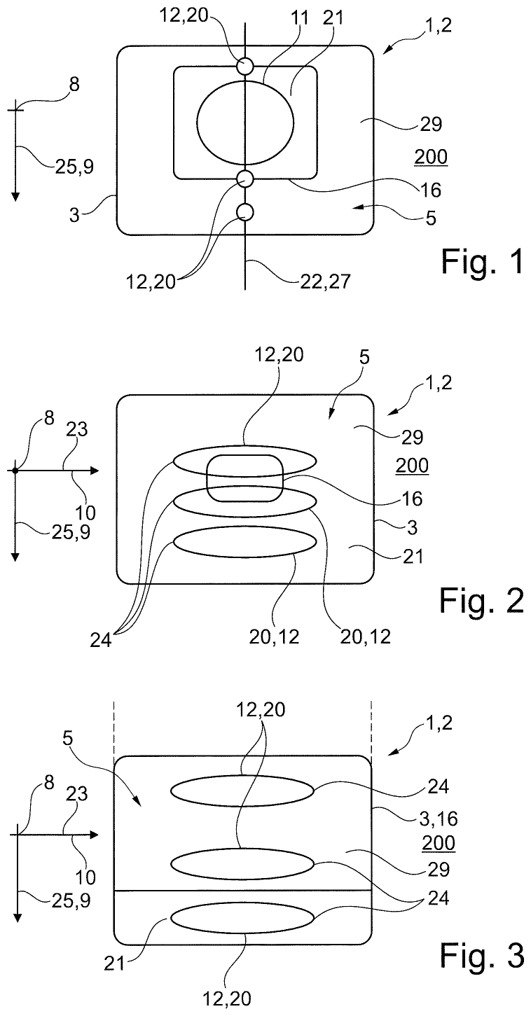

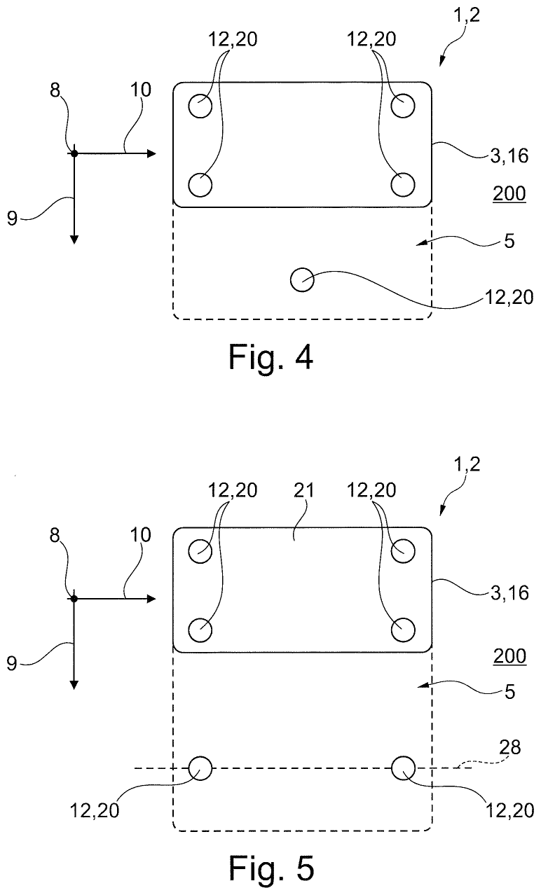

FIGS. 1 to 10 show preferred embodiments of an induction charging apparatus designated in each case as a whole by the reference number 1. For the sake of simplicity, functionally identical or functionally similar components are given the same reference signs in the embodiments. In order to avoid repetition, a fresh description of functionally identical or functionally similar components is not provided.

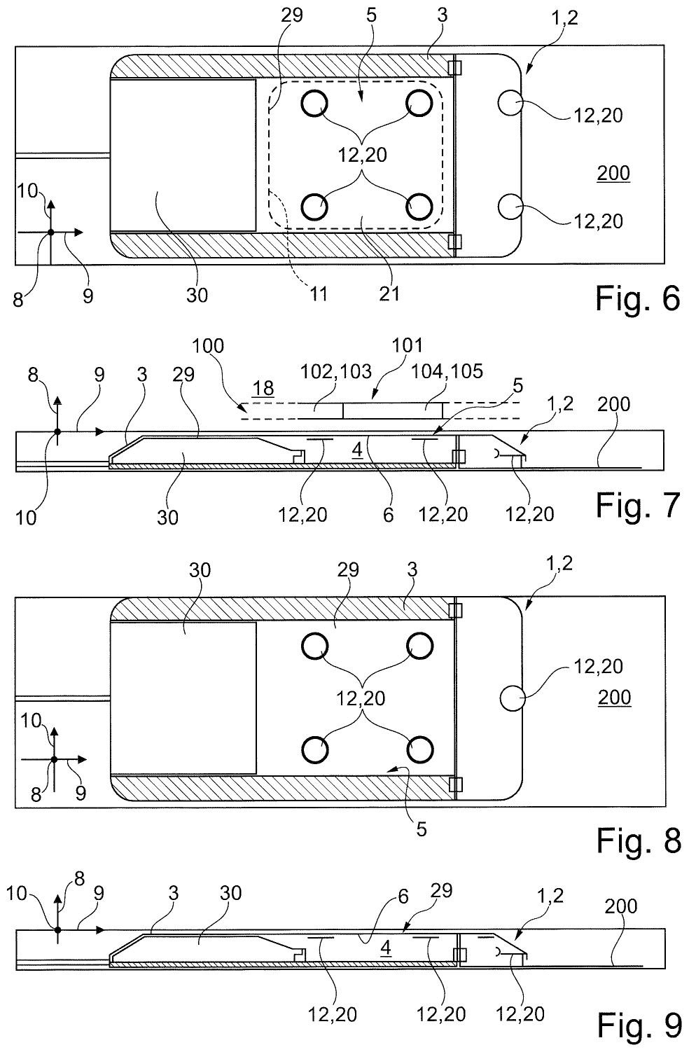

With regard to FIG. 1, a preferred embodiment of an induction charging apparatus 1 can be seen, which is suitable for a stationary charging station 2 or is installed there, which is configured for charging a battery-electric vehicle 100, which is only indicated in FIG. 7 and only symbolically, for example an electric vehicle, with electrical energy. It comprises an exemplary, for example cuboid support structure 3, which defines a vertical direction 8 indicated by a plus sign. By way of example, the vertical direction 8 is perpendicular to a flat housing wall 5 of the support structure 3 lying in the plane of the drawing, which is oriented parallel to and facing away from a surface 200 on which said vehicle 100 is parked. The housing wall 5 expediently has or forms a flat outer large surface 29 facing the vehicle 100, which in particular is opposite an inner surface 6 of the housing wall 5 facing an inner space 4 of the support structure 3, wherein the vertical direction 8 is preferably perpendicular to the outer large surface 29, cf. in particular FIGS. 6 to 9.

Inside the support structure 3, i.e. in the inner space 4 of the support structure 3, an electrical energy coil 11 is arranged, which is only symbolically indicated in FIGS. 1 and 6 to 9 and is configured for inductive, bidirectional interaction with an electrical vehicle energy coil 103 of a vehicle induction charging apparatus 101 of the vehicle 100 arranged in a vehicle base housing 102, cf. in particular FIGS. 6 to 9 again. The electrical energy coil 11 defines a coil plane 21. Said vertical direction 8 is perpendicular to the coil plane 21. The coil plane 21 usually lies in the horizontal plane spanned by the longitudinal direction 9 and the transverse direction 10. In FIGS. 1 to 6 along with 8 and 10, the coil plane 21 is at least substantially in or parallel to the sheet plane, while in FIGS. 7 and 9 it is at least substantially orthogonal to the sheet plane. As a result, electrical energy can be transferred inductively from the induction charging apparatus 1 to the vehicle 100 within the framework of the charging operation 18, or vice versa. Using the electrical energy coil, a virtual target region 16 or a virtual target volume is marked or provided for the vehicle induction charging apparatus 101 of the vehicle 100, within which the vehicle induction charging apparatus 101 is positioned or can be positioned with respect to the induction charging apparatus 1 for a particularly energy-efficient charging operation 18 or to establish such an operation in such a way that the energy coil 11 and the vehicle energy coil 103 are opposite one another at a distance in the vertical direction 8 and overlap transversely to the vertical direction 8 or lie completely congruently on top of one another. The induction charging apparatus 1 also comprises a transmitting device 12 that comprises at least one electrical transmission coil 20 that is separate with respect to the energy coil 11, hereinafter referred to as the guide-path-marking transmission coil or FPM transmission coil, which transmission coil provides an electromagnetic field, hereinafter referred to as the guide-path-marking field or FP marking field, or is configured to provide such a field. Using the at least one FP marking field, a guide path 22 leading to the target region 16 and oriented transversely to the vertical direction 8 can be marked or provided for the vehicle induction charging apparatus 101 of the vehicle 100, using which the vehicle induction charging apparatus 101 or the vehicle 100 can be guided or is guided to the target region 16. As a result, in particular a simple approach of the same to the induction charging apparatus 1 is possible. Furthermore, a soft, so-called “smoother” transition to or from a remote positioning method can be realized. The at least one FPM transmission coil 20 is fastened to the support structure 3 spaced apart from the electrical energy coil 11 in a longitudinal direction 9 perpendicular to the vertical direction 8, wherein the at least one FPM transmission coil 20 is positioned in the inner space 4 bounded by the support structure 3 and is arranged, for example, on the inner surface 6 of the housing wall 5 of the support structure 3 that is oriented towards the inner space 4; see also FIGS. 7 and 9. The electrical transmission coil 20 designed as an FPM transmission coil can also comprise a magnetic flux guide unit with magnetic flux guide elements, in particular ferrite plates, for guiding magnetic or electromagnetic fields, in particular the generated FP marking fields.

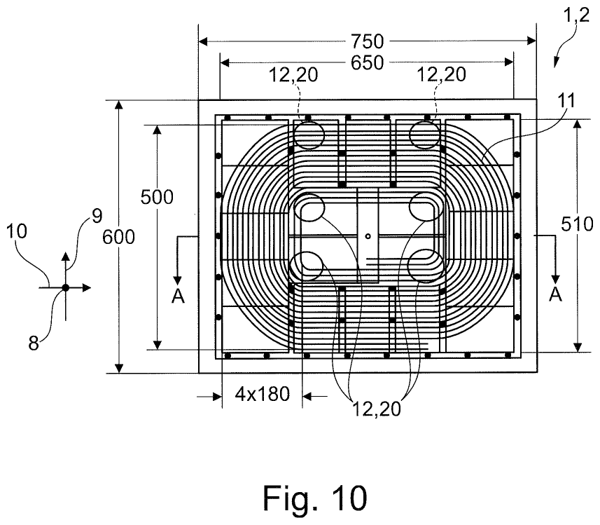

In FIGS. 1 to 4, three, in FIG. 5 two, in FIGS. 6 and 7 six, in FIGS. 8 and 9 five, and in FIG. 10 four along with two further optional FPM transmission coils 20 are arranged on the support structure 3, wherein their FP marking fields are staggered one behind the other in the longitudinal direction 9. By way of example only, the FPM transmission coils 20 shown in FIGS. 1, 4 to 9 are circular FPM transmission coils with a circular outer contour. The at least one FPM transmission coil can also comprise a rectangular outer contour and then forms a rectangular coil.

The FPM transmission coils 20 as shown in FIGS. 2, 3 form so-called electromagnetic long coils 24 that extending in a main coil direction 23. The extent of each long coil 24 is greater in the main coil direction 23 than in a transverse coil direction 25 perpendicular to the main coil direction 23. Expediently, the main coil directions 23 and the long coils 24 are orthogonal in relation to the longitudinal direction 9. The guide path 22, which is only indicated in FIG. 1, leads to the target region 16 or to a geometric center of the same and expediently through an intensity maximum of the electrical energy coil 11.

According to FIG. 6 to FIG. 10, the at least one energy coil 11 comprises a rectangular outer contour and forms a rectangular coil. This is shown in FIG. 10 by a broken line and can also be transferred to FIG. 8. An electronic unit 30, in particular for controlling the induction charging apparatus 1, is arranged on the left of the energy coil 11 in FIGS. 6 to 9.

With reference to FIG. 1, it can be seen that the FPM transmission coil 20 there is arranged on a longitudinal straight line 27 aligned parallel to the longitudinal direction 9. Furthermore, with reference to FIG. 5, it can be seen that the FPM transmission coils 20 there are arranged one behind the other on a transverse straight line 28, which is aligned orthogonally to the longitudinal direction 9 and parallel to a transverse direction 10. The respective adjacent FPM transmission coils 20 are, as can obviously be seen, spaced apart relative to one another in the longitudinal direction 9 and in the transverse direction 10.

1. An induction charging apparatus for a charging station configured for charging a battery-electric vehicle with electrical energy, comprising:
a support structure, on, in or next to which an electrical energy coil is arranged, the electrical energy coil configured for inductive interaction with an electrical vehicle energy coil of a vehicle induction charging apparatus of the vehicle, such that electrical energy can be transferred inductively from the induction charging apparatus to the vehicle, or vice versa,
a transmitting device that comprises at least one electrical transmission coil separate with respect to the energy coil the at least one transmission coil provides an electromagnetic field or a magnetic field, or is configured to provide such a field, and
a guide is provided using at least one FP marking field for the vehicle induction charging apparatus of the vehicle via which the vehicle induction charging apparatus of the vehicle can be guided to the electrical energy coil.

2. The induction charging apparatus according to claim 1, wherein the at least one electrical transmission coil is an FPM transmission coil arranged away from the electrical energy coil or at a distance from the electrical energy coil.

3. The induction charging apparatus according to claim 1, wherein:
the electrical energy coil spans a coil plane,
the support structure defines a vertical direction orthogonally aligned in relation to the coil plane,
the at least one electrical transmission coil is an FPM transmission coil arranged on the support structure spaced apart from the energy coil in a longitudinal direction perpendicular to the vertical direction, and/or
the at least one electrical transmission coil is an FPM transmission coil positioned in an inner space bounded or formed by the support structure and/or is arranged on an inner surface of a housing wall of the support structure that is oriented towards the inner space.

4. The induction charging apparatus according to claim 1, wherein the at least one electrical transmission coil is an FPM transmission coil that comprises at least one of the following features,
the at least one FPM transmission coil is a flat coil,
the at least one FPM transmission coil is smaller than the electrical energy coil,
the at least one FPM transmission coil comprises a circular outer contour and forms a circular FPM transmission coil,
the at least one FPM transmission coil comprises a rectangular outer contour and forms a rectangular coil,
the at least one FPM transmission coil is a long coil that extends in a main coil direction,
the extent of the long coil in the main coil direction (23) is greater than in a transverse coil direction perpendicular to the main coil direction,
the main coil direction is perpendicular in relation to a vertical direction of the support structure, or the main coil direction is perpendicular in relation to a longitudinal direction perpendicular to a vertical direction of the support structure.

5. The induction charging apparatus according to claim 1, wherein:
the at least one FP marking field that is provided or can be provided by the at least one electrical transmission coil that is an FPM transmission coil has a marking intensity maximum, and/or
wherein the marking intensity maximum forms at least a global maximum.

6. The induction charging apparatus according to claim 1, wherein the guide is directed towards the electrical energy coil and/or leads to the electrical energy coil.

7. The inductive charging apparatus according to claim 1, wherein:
the support structure defines a vertical direction,
the transmitting device comprises two, four, six or more electrical transmission coils configured as FPM transmission coils, which are arranged spaced apart from the energy coil on the support structure in a longitudinal direction perpendicular to the vertical direction and which runs parallel to a surface on which the battery-electric vehicle is parked, and/or
the two, four, six or more electrical transmission coils configured as FPM transmission coils are in each case positioned in an inner space bounded or formed by the support structure and/or are arranged on an inner surface of a housing wall of the support structure that is oriented towards the inner space.

8. The inductive charging apparatus according to claim 7, wherein:
the electrical transmission coils configured as FPM transmission coils are arranged one behind the other on a longitudinal straight line aligned parallel to the longitudinal direction or on a longitudinal curve, or
the electrical transmission coils configured as FPM transmission coils are arranged one behind the other on a transverse straight line that is aligned parallel to a transverse direction perpendicular to the vertical direction and the longitudinal direction, and/or
adjacent electrical transmission coils configured as FPM transmission coils are spaced apart relative to one another or relative to one another in the longitudinal direction or relative to one another in the transverse direction.

9. The inductive charging apparatus according to claim 1, wherein:
FP marking fields provided by electrical transmission coils configured as FPM transmission coils can be differentiated from one another, and/or
the FP marking field that is provided or can be provided by the at least one electrical transmission coil configured as an FPM transmission coil comprises an individual coding, and/or
wherein the individual coding of the FP marking field of an electrical transmission coil (20) designed configured as an FPM transmission coil makes it possible to differentiate this FPM transmission coil from FP marking fields of other FPM transmission coils of the transmitting device (12), and/or
the individual coding of the FP marking field provided or to be provided by the at least one electrical transmission coil configured as an FPM transmission coil is realized using a marking intensity maximum of the FP marking field.

10. The inductive charging apparatus according to claim 1, wherein:
the at least one electrical transmission coil is an FPM transmission coil assigned to a ferrite element of the electrical energy coil arranged on the electrical energy coil and/or the electrical transmission coil is an FPM transmission coil that comprises a ferrite element, or
the at least one electrical transmission coil is an FPM transmission coil that comprises a magnetic flux guide unit with magnetic flux guide elements for guiding magnetic or electromagnetic fields.

11. A vehicle induction charging apparatus for a battery-electric vehicle, comprising:
an electrical vehicle energy coil that is arranged in a vehicle base housing and is configured for inductive interaction with an electrical energy coil of an induction charging apparatus for a stationary charging station, which is configured for charging battery-electric vehicles with electrical energy, to transfer electrical energy inductively from the induction charging apparatus to the vehicle, or vice versa,
a receiving device that is arranged in the vehicle base housing and comprises at least one electrical receiver coil that receives at least one electromagnetic field, designated as a guide-path-marking field or FP marking field, or a magnetic field of an electrical transmission coil, configured as a guide-path-marking transmission coil or FPM transmission coil, of a transmitting device of the induction charging apparatus, and
a control device or a computer unit which, using at least one received FP marking field, recognizes or is configured for recognizing that the vehicle induction charging apparatus and/or the vehicle is approaching the induction charging apparatus.

12. An energy transfer apparatus, comprising:
having an induction charging apparatus configured for a stationary or mobile application and a vehicle induction charging apparatus configured for a stationary or mobile application,
the induction charging apparatus including:
a support structure, on, in or next to which an electrical energy coil is arranged, the electrical energy coil configured for inductive interaction with an electrical vehicle energy coil of a vehicle induction charging apparatus of the vehicle, such that electrical energy can be transferred inductively from the induction charging apparatus to the vehicle, or vice versa,
a transmitting device that comprises at least one electrical transmission coil separate with respect to the energy coil, the at least one transmission coil provides an electromagnetic field or a magnetic field, or is configured to provide such a field, and
a guide is provided using at least one FP marking field for the vehicle induction charging apparatus of the vehicle, via which the vehicle induction charging apparatus of the vehicle can be guided to the electrical energy coil;
the vehicle induction charging apparatus including:
an electrical vehicle energy coil that is arranged in a vehicle base housing and is configured for inductive interaction with an electrical energy coil of an induction charging apparatus for a stationary charging station, which is configured for charging battery-electric vehicles with electrical energy, to transfer electrical energy inductively from the induction charging apparatus to the vehicle, or vice versa,
a receiving device that is arranged in the vehicle base housing and comprises at least one electrical receiver coil that receives at least one electromagnetic field, designated as a guide-path-marking field or FP marking field, or a magnetic field of an electrical transmission coil, configured as a guide-path-marking transmission coil or FPM transmission coil, of a transmitting device of the induction charging apparatus; and
wherein the induction charging apparatus (1) and/or the vehicle induction charging apparatus comprises a control device or a computer unit, which, using at least one received FP marking field, recognizes or is configured to recognize that the vehicle induction charging apparatus and/or the vehicle is approaching the induction charging apparatus.

13. A combination of an energy transfer apparatus according to claim 12 and a battery-electric vehicle,
wherein the stationary induction charging apparatus is fastened with its support structure on the ground side to or at least in sections recessed in a surface on which the battery-electric vehicle is parked, and
wherein the mobile vehicle induction charging apparatus is fastened with its vehicle base housing to a vehicle structure of the battery-electric vehicle.

14. A method for bringing a vehicle induction charging apparatus according to claim 11 to an induction charging apparatus, the induction charging apparatus including:
a support structure, on, in or next to which an electrical energy coil is arranged, the electrical energy coil configured for inductive interaction with an electrical vehicle energy coil of a vehicle induction charging apparatus of the vehicle, such that electrical energy can be transferred inductively from the induction charging apparatus to the vehicle, or vice versa,
a transmitting device that comprises at least one electrical transmission coil separate with respect to the energy coil, the at least one transmission coil provides an electromagnetic field or a magnetic field, or is configured to provide such a field, and
a guide is provided using at least one FP marking field for the vehicle induction charging apparatus of the vehicle, via which the vehicle induction charging apparatus of the vehicle can be guided to the electrical energy coil;
wherein, via at least one electrical receiver coil of the receiving device of the vehicle induction charging apparatus, an FP marking field of at least one electrical transmission coil of the transmitting device of the induction charging apparatus, which is configured as an FPM transmission coil, is received,
wherein a control device or computer unit installed in the induction charging apparatus and/or the vehicle induction charging apparatus recognizes or ascertains using at least one received FP marking field that the vehicle induction charging apparatus and/or the vehicle is approaching the induction charging apparatus.

15. The method according to claim 14, wherein the vehicle induction charging apparatus is equipped on a battery-electric vehicle.

16. The energy transfer apparatus according to claim 12, wherein the at least one electrical transmission coil is an FPM transmission coil assigned to a ferrite element of the electrical energy coil arranged on the electrical energy coil and/or the electrical transmission coil is an FPM transmission coil that comprises a ferrite element.

17. The energy transfer apparatus according to claim 12, wherein the at least one electrical transmission coil is an FPM transmission coil that comprises a magnetic flux guide unit with magnetic flux guide elements for guiding magnetic or electromagnetic fields.

18. The induction charging apparatus according to claim 1, wherein the guide comprises a guide path.

19. The induction charging apparatus according to claim 1, wherein the at least one transmission coil provides the at least one FP marking field.

20. The induction charging apparatus according to claim 1, wherein the at least one transmission coil is a guide-path-marking transmission coil or FPM transmission coil.
